(19) United States
(12) Patent Application Publication
(10) Pub. No.: US 2016/0097422 A1
(43) Pub. Date: Apr. 7, 2016

(54) Self Locking Pivot Mount for Machine Mounted Devices

(71) Applicant: John Burke, Tampa, FL (US)

(72) Inventor: John Burke, Tampa, FL (US)

(21) Appl. No.: 14/504,106

(22) Filed: Oct. 1, 2014

(51) Int. Cl. F16C 11/10

(52) U.S. Cl. CPC F16C 11/10

(57) ABSTRACT

An improved Mount for Machine Mounted Devices. The self locking pivot mount improves on the previous designs by incorporating an enclosed mechanism that implements a self locking position or multiple positions. The self locking position or multiple positions enables deterministic pivot mount position, thus enabling designed limits on cable strain and contact with other structures. It further securely positions the pivot mount in a defined position, eliminating accidental undesired changes in position.

### BACKGROUND OF THE INVENTION

1. Field of the Invention

The invention relates to the mounting of a device or devices to a machine which conveys and/or processes material or products, hereafter referred to as machine(s). These machines sometimes have a bed track along which the material travels. Others do not have a bed track but utilize some other support for the material or product. Still others have a moving belt that transports the material or product. Other types of machines uses chains with clips that support and transport the material or product. The preceding are examples of machines and are not intended to be limiting in any way. The invention is applicable to a wide variety of material and product conveying and/or processing machines. The terms material and products are intended in the broadest possible form and are not intended to be limiting.

The possible materials vary and are comprised of, but are not limited to, metals such as aluminum or steel, a variety of plastics, composites and combinations thereof. Other materials and combinations of materials are also possible. The material itself may be flat, formed or a combination thereof. The products may be of essentially any form or type suitable for machine processing and the term is not intended to be limiting. The preceding are examples of materials and products, and are not intended to be limiting in any way.

Generally the invention is applicable to devices which mount at least in part above and/or below the material being conveyed. The type of material or product or its form is not important to the invention. Examples of such machines include, but are not limited to, pharmaceutical packaging, medical packaging, metal rolling, metal forming, plastic forming, food packaging, beverage packaging machines or combinations thereof. Examples of devices to be mounted include, but are not limited to, pinhole inspection, machine vision systems, bar code readers, printers, labeling, machine tooling or combinations thereof. The term devices is intended in its broadest form and is not to be constrained by previous examples.

2. Background Art

Various mounting designs exist for mounting devices to the machine. Most are fixed to the machine or a part of the machine. Some are made so the device can be removed from the mount and the mount left attached to the machine, while others remove both the mount and the device.

Some machines can be configured to utilize different materials or products and/or forms of material or products. These machines typically have different parts that need to be changed to accommodate the material or product and/or material form change. Machines that utilize bed tracks often need to change the bed track when doing the preceding changes. Machines without a bed track may also need to change parts as well to accommodate the material or product change.

Devices and/or the mounts mounted to the machine may interfere with or make difficult the machine parts, material or product change. It is therefore desirable that the device mounting minimizes any interference with changing machine parts, material or products.

Many previous device mounts require the device and/or the mount to be removed before changing machine parts for machine configuration changes. Others are intended to allow removal of the machine part without removing the device and/or mounting. An example of one such mount has an opening in the front of the mount that permits removal of parts (e.g. a bed track) by sliding it out. Another example improves on the open mount design and has a hinge at the rear of the mount which allows the upper section of the mount to be lifted up, allowing the part (e.g. bed track) to be lifted as well as slid, making removal easier.

The invention is an improvement on previous pivot lift mount designs which did not limit or fix the lifted position or positions inherently, rather the lift mount position was limited by contact with some other object (e.g. machine structure) or restrained by device cabling.

### BRIEF SUMMARY OF THE INVENTION

The invention improves on the previous designs by incorporating an enclosed mechanism that implements a self locking position or multiple positions. The self locking position or multiple positions enables deterministic pivot mount position, thus enabling designed limits on cable strain and contact with other structures. It further securely positions the pivot mount in a defined position, eliminating accidental undesired changes in position. Removal from a self locking position is easily accomplished by applying a minimal force to disengage the self locking mechanism. Further, the self locking mechanism is totally enclosed within the mount thereby facilitating cleaning and eliminating external parts that may be damaged or lost. The preceding discussion of the self locking position feature is also applicable to a mount section below the material, with the pivot section below the material and the lower section doing the pivoting and utilizing the self locking position(s) feature. In summary, the self locking position feature of the mount can be used above the material, below the material or both.

In the broadest form, the invention consists of a mount or portion of a mount, positioned above the material or product, below the material or product, or both, on a machine which conveys and/or processes said material or products. Further, the invention incorporates a self locking position or multiple positions mechanism incorporated within the mounting structure.

In the following section, one embodiment of the invention is explained in detail. For simplicity, a single pin-receptacle embodiment is described. The design is easily extrapolated to include multiple pin-receptacle designs. Likewise, the embodiment described utilizes a single spring at one end of the pivot shaft. One spring can be extrapolated to multiple springs, comprising multiple compression springs, multiple tension springs or combinations thereof. So to could the spring or multiple springs arrangement be comprised of a location at one end or both ends, in compression, tension or combinations thereof. The invention is not intended to be limited in its application to the details of construction and to the arrangements of the components described in the following description or illustrated in the drawings. The invention is capable of other embodiments and of being practiced and carried out in various ways.

The phraseology and terminology employed herein are for the purpose of description and should not be regarded as limiting.

It is the intention of the invention to provide an improved mount for a plethora of devices used with machines that convey and/or process material or products. The invention incorporates a self locking position or multiple positions for a pivot mount. The enclosed self locking position or multiple position mount overcomes the disadvantages of previous mounts which is not anticipated, rendered obvious, suggested, or even implied by any of the prior art, either alone or in any combination.

### BRIEF DESCRIPTION OF THE DRAWINGS

The following drawings illustrate the best modes presently contemplated for carrying out the present invention (Preferred Embodiment):

FIG. 1 Primary Components

FIG. 2 Fixed Mount Assembly Components

FIG. 3 Fixed Mount Structure

FIG. 4 Pivot Shaft Slot Receptacle and Hexagonal Locking Pin

FIG. 5 Pivot Shaft Hole Receptacle and Cylindrical Locking Pin

FIG. 6 View From Above of Mount and Material

FIG. 7 Hexagonal Locking Pin Mechanism in Unlocked Position

FIG. 8 Hexagonal Locking Pin Mechanism in Locked Position

FIG. 9 Cylindrical Locking Pin Mechanism in Unlocked Position

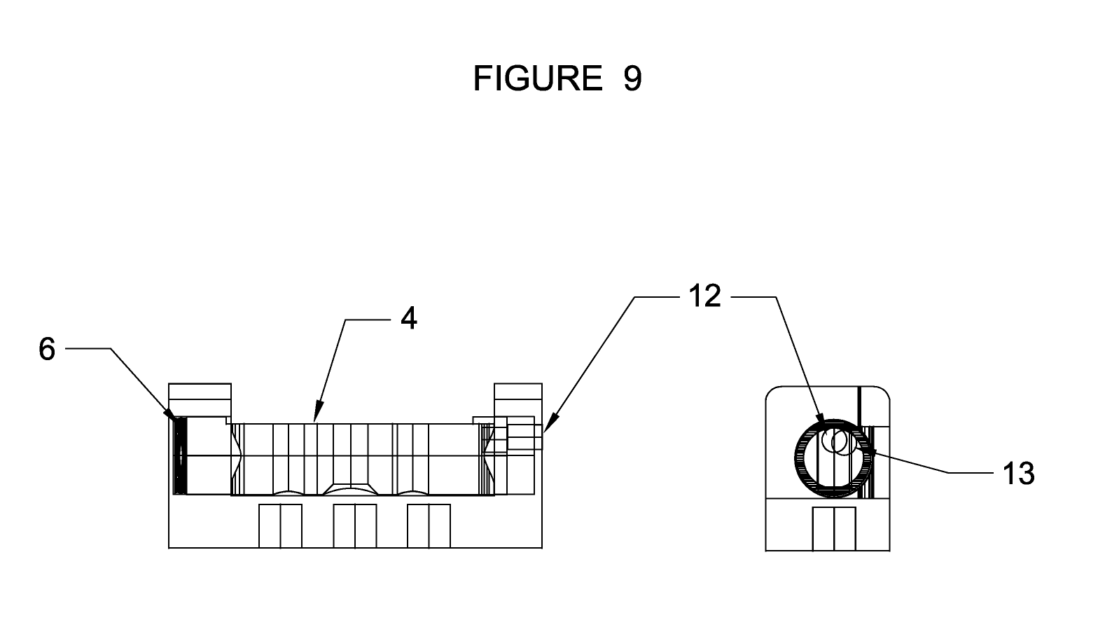

FIG. 10 Cylindrical Locking Pin Mechanism in Locked Position

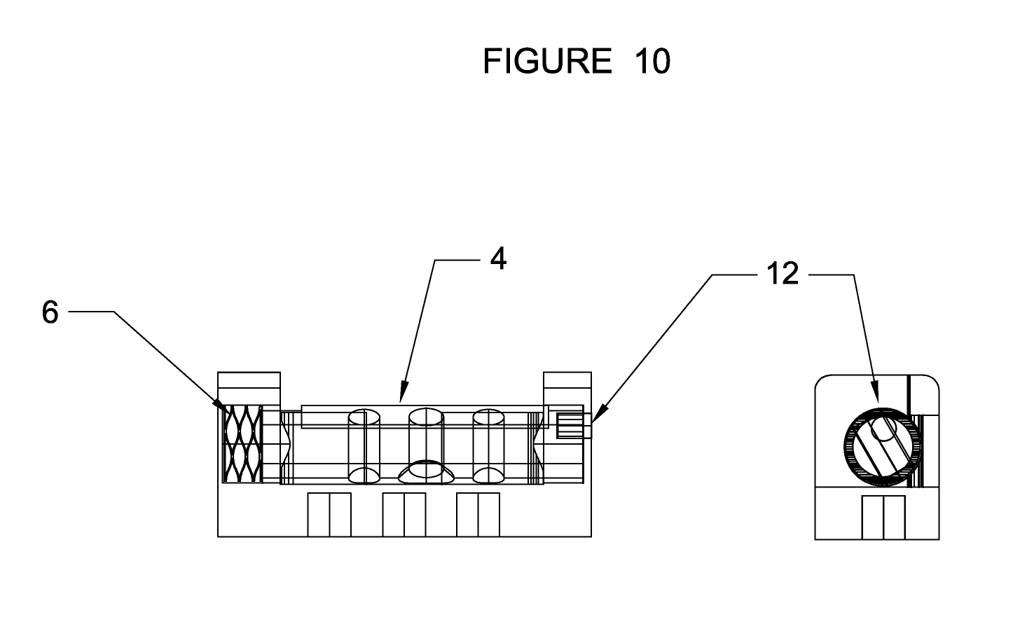

### DETAILED DESCRIPTION OF THE INVENTION

### Principle of Operation

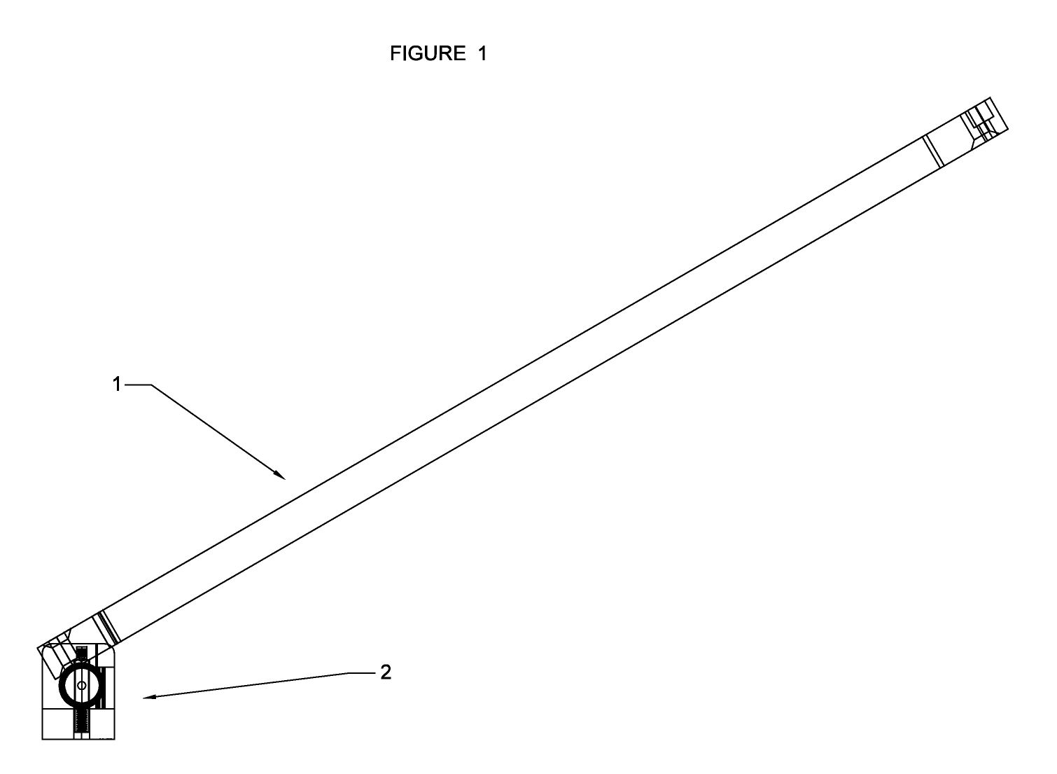

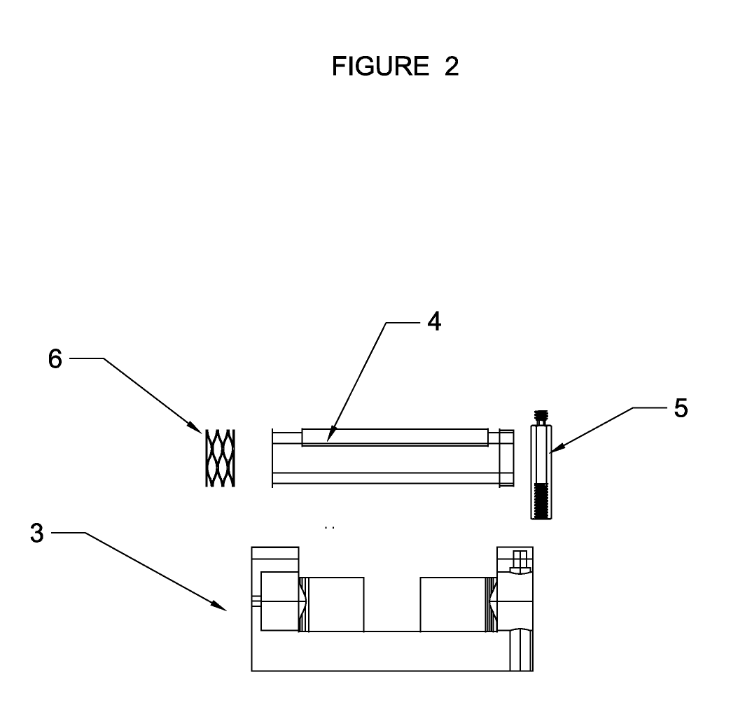

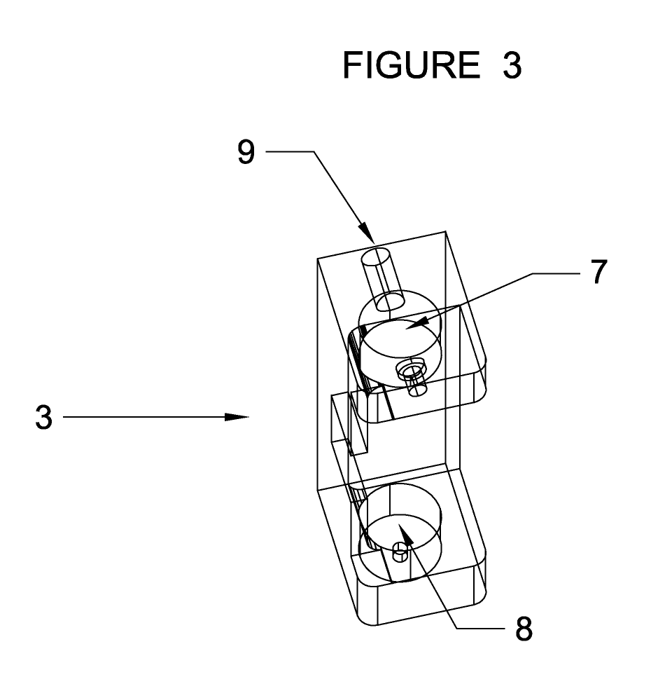

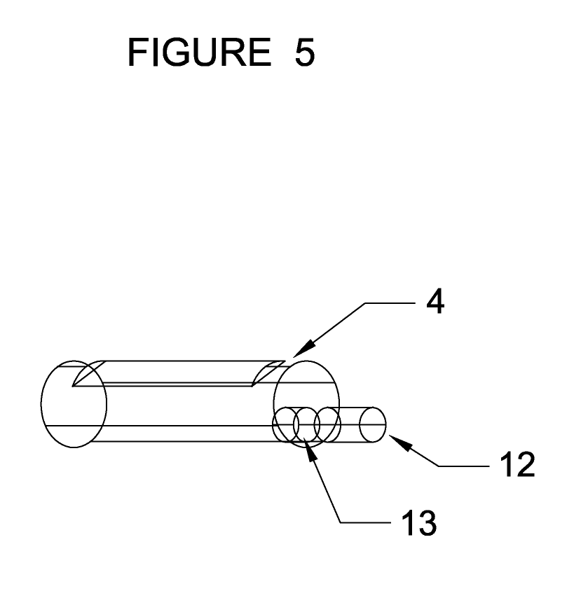

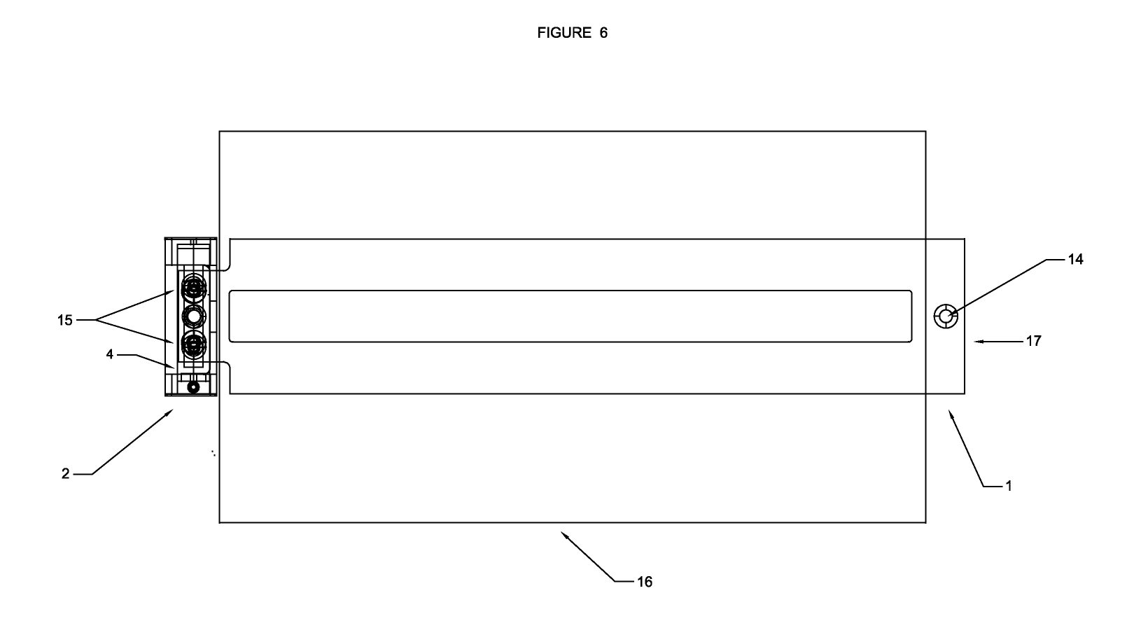

The invention forms a self locking position or multiple position mechanism for a pivoting mount. It comprises a fixed mount assembly and a pivoting section. The fixed portion comprises a structure which encompasses the self locking feature within. In use, an operator moves the pivoting section until a self locking position is reached and the mechanism engages. The pivoting section is retained in the locked position until the operator applies a small force to release the self locking feature, thereby enabling the pivoting section to rotate. Refer to FIGS. 1 through 8 for the following description.

### The Components:

The preferred embodiment is comprised of two primary components: the fixed mount assembly 2 mounted to or within the machine structure or component and a pivot mount 1 which is connected to the pivot shaft of the fixed mount assembly.

The fixed mount assembly 2 of the preferred embodiment is comprised of the fixed mount structure 3, a pivot shaft 4, a locking pin 5 and a compression spring 6.

The fixed mount structure 3 comprises a pivot shaft housing 7, said housing comprising bearing surfaces at least partially encompassing the pivot shaft, said pivot shaft housing further comprising a spring cavity 8 for the spring 6. Said pivot shaft housing 7 dimensions comprise a non-restraining rotating and sliding fit to the pivot shaft 4. The structure further comprises a locking pin hole 9, said hole at least partially encompassing the locking pin 5 and facilitating the fixing in place of the locking pin. The fixed mount material is comprised of aluminum in the preferred embodiment, but could be comprised of a plethora of suitable materials including, but not limited to, steel, stainless steel, plastics, composites or combinations thereof.

The pivot shaft 4 is comprised of a suitable shaft material, in the case of the preferred embodiment, aluminum. A plethora of materials could be utilized, including but not limited to, steel, stainless steel, plastics, composites or combinations thereof. The pivot shaft 4 further comprises a slot receptacle 10 in one end which is formed to accommodate the hexagonal locking pin 5 within it. The pivot shaft 4 has a flattened area 11 along its length to accommodate connection of the pivot mount. Said flattened area is present in the preferred embodiment but is not necessary for the invention.

The locking pin 5 comprises a shape, dimensions and material strength that interfaces with the slot receptacle 10 in the pivot shaft 4 and performs the function to prevent the rotation of the pivot shaft when said pivot shaft is engaged with the locking pin. The locking pin comprises a hexagonal shaft 5, said locking pin oriented in a direction perpendicular to the longitudinal direction of the pivot shaft 4 and said pin presenting flat interface surfaces which correspond to the flat surfaces of the pivot shaft slot 10 that forms the locking pin receptacle. The single locking pin receptacle could easily be extrapolated to multiple receptacles. Said multiple receptacle embodiments could further comprise multiple locking positions.

The preferred embodiment locking pin to pivot shaft interface includes an alternate form description. The alternate form comprises a cylindrical shaft for the locking pin 12, said locking pin oriented in the same longitudinal direction of the pivot shaft 4 and presenting a protruding portion of a cylindrical shaft 12 which corresponds to a cylindrical shaped hole 13 in the end of the pivot shaft that forms the locking pin receptacle. The cylindrical shaft locking pin hole is depicted as formed into the fixed base structure, however an equivalent form is the pins held by an additional plate attached to the fixed mount structure in the same approximate position as the formed hole. The single locking pin description could easily be extrapolated to multiple locking pins. Said multiple pin embodiments could further comprise multiple locking positions.

The preferred embodiment presents possible embodiments for the locking pin to pivot shaft interfaces. Other embodiments comprise various dimensions, shapes, orientations, configurations, number and combinations thereof for the locking pin to pivot shaft interface. The primary requirement is to prevent rotation of the pivot shaft once engaged.

The spring 6 comprises a form which fits into the spring cavity of the fixed mount structure and a spring force capable of moving the pivot shaft into the locked position or multiple positions. In the preferred embodiment the spring comprises an other diameter less than the pivot shaft diameter, a compressed length that fits into the spring cavity when it is compressed by the pivot shaft. The spring is further comprised of a extended length and a spring constant sufficient to cause the pivot shaft receptacle 10,13 to engage the locking pin 5,12 and remain engaged.

A plethora of combinations of spring, spring type, spring number, spring cavity and spring force are suitable for the function. The preferred embodiment describes a single compression spring design. The locking mechanism may be comprised of one or multiple compression springs, tension springs or combinations thereof. Variables such as weight and size (among others) may influence the embodiment of the invention. The description of the preferred embodiment is not intended to limit the spring, spring type, spring number, spring cavity, spring force or combinations thereof in any way.

The pivot mount 1 of the preferred embodiment is comprised of a support structure to which a device or multiple devices are attached, provisions to attach 14 said device or multiple devices to the structure, and provisions 15 to attach the pivot mount 1 to the pivot shaft 4 of the fixed mount assembly 2.

Although the pivot mount of the preferred embodiment is comprised of a structure to which a device is mounted or attached, some devices may not need the pivot mount structure and may be capable of being directly mounted to the pivot shaft. In such cases, the pivot mount component 1 is not necessary.

The support structure of the pivot mount 1 is comprised of a form and material sufficient to support the device or multiple devices mounted to it and facilitate their function. In the preferred embodiment the pivot mount 1 form is comprised of a rectangular bar which spans the machine material, product or bed track 16 in a direction approximately perpendicular to the material direction of travel. The perpendicular direction is not essential and the invention could be utilized in a variety of orientations. The material in the preferred embodiment is comprised of aluminum. A plethora of materials are suitable for the pivot mount and include, but are not limited to steel, stainless steel, plastic, composites or combinations thereof. Likewise the form of the pivot mount can take a plethora of forms, providing they perform the device attachment and support, and pivot shaft attachment functions.

The attachment of devices to the pivot mount 1 support structure in the preferred embodiment is comprised of removable fasteners. A plethora of fasteners are capable of being utilized, including but not limited to, screws, bolts, and quick release pins. The attachment of devices to the support structure may be comprised of removable or permanent means. Permanent attachment means include, but are not limited to, welding and adhesives.

The attachment of the pivot mount structure 1 to the to the pivot shaft 4 in the preferred embodiment is comprised of removable fasteners. A plethora of fasteners are capable of being utilized, including but not limited to, screws, bolts, and quick release pins. The attachment of devices or the pivot mount structure to the pivot shaft 4 may be comprised of removable or permanent means. Permanent attachment means include, but are not limited to, welding and adhesives.

### Description of Operation

The following description refers to the preferred embodiment and is not intended to limit the invention in any manner. The invention is capable of being implemented in various other forms. It is likewise not intended to provide an all inclusive description but rather illustrates the principle of operation so the invention can be understood. Although this description illustrates an above the material application, it is likewise capable of being utilized below the material, or both.

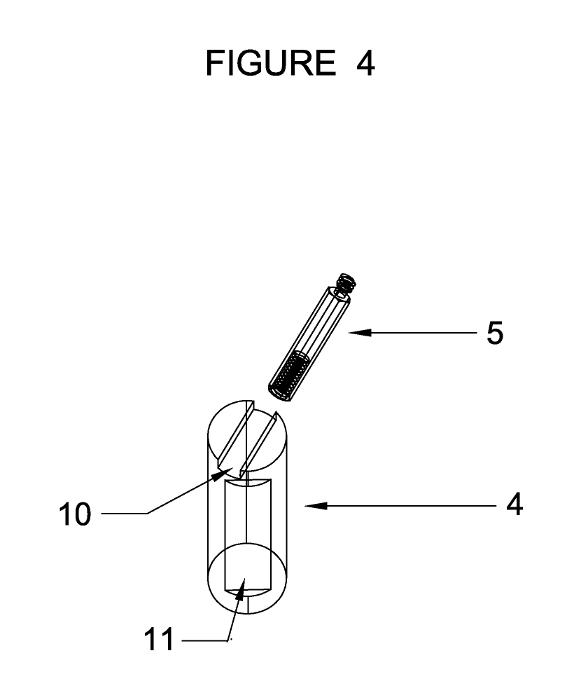

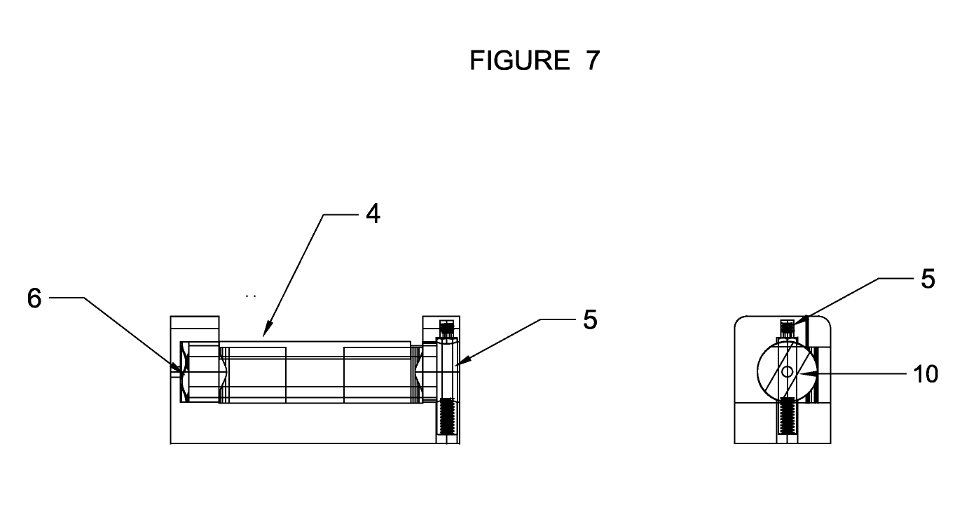

Referring to FIG. 7, when the pivot shaft 4 is not in a locked position, the pivot shaft 4 lateral movement is constrained on the end with the receptacle 10 (FIG. 4) by the locking pin 5 (which is not engaged) and on the other end by the compressed spring 6. In this position the pivot mount is approximately centered in respect to the fixed mount assembly 2. This example is for the hexagonal pin form, but easily translates to the cylindrical pin form of the shaft to locking pin mechanism.

When it is desired to move the pivot mount to the locked position, a user moves the pivot mount 1 by the proximal end 17, thus rotating the pivot shaft 4. As the pivot shaft rotates it continues to experience a lateral force from the compressed spring 6 in the direction of the locking pin. When the pivot shaft 4 is rotated to the position where the receptacle 10 of the pivot shaft aligns with the locking pin 5, the force exerted by the compressed spring 6 moves the pivot shaft 4 laterally towards the locking pin 5 and engages the locking pin. In the locked (engaged) position the spring 6 is compressed sufficiently to exert a force to prevent the pivot shaft 4 form moving laterally away from the locking pin 5, thus holding the lift mount in the locked position. In this locked position, refer to

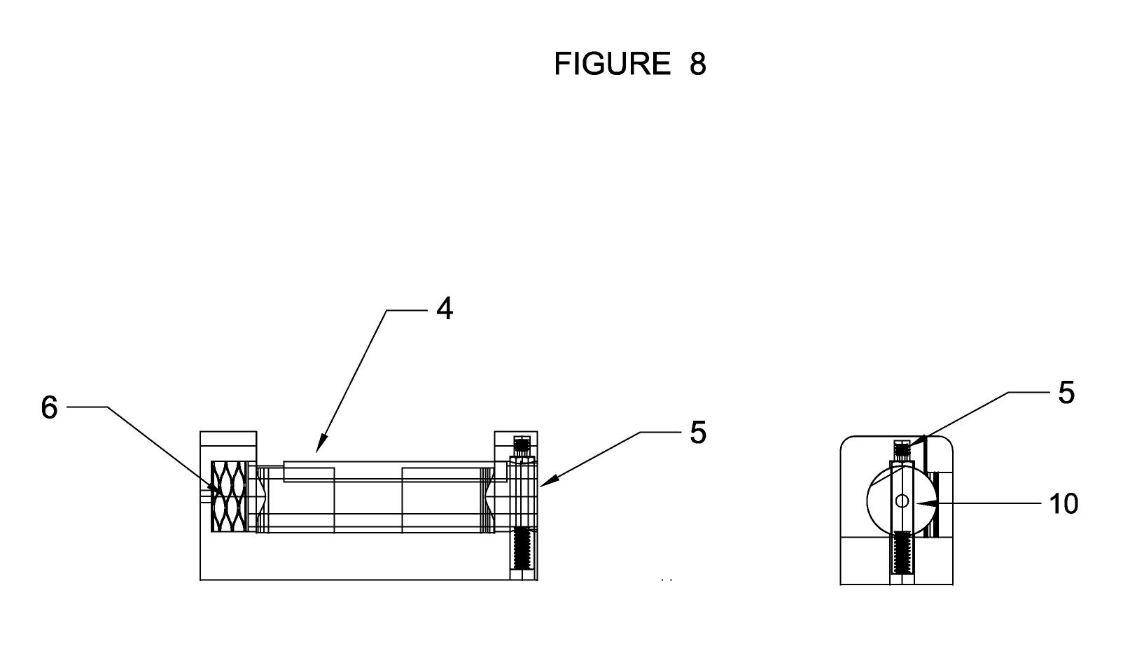

FIG. 8, the pivot mount is off center in respect to the fixed mount assembly 2 by the amount the pivot shaft moved laterally to engage the locking pin. Again, this description easily translates to the cylindrical shaped pin form of the shaft to locking pin mechanism.

When it is desired to move the pivot mount to an unlocked position, the user exerts a small force so as to move the pivot shaft 4 against the force of the compressed spring 6 and towards the center position with respect to the fixed mount assembly 2. When the center position is approximately reached the pivot shaft is disengaged from the locking pin and is free to rotate.

1) Enclosed mechanism self locking pivot mount for devices used on machines comprising:
a pivot shaft, said pivot shaft comprising a nominally cylindrical shape, one or multiple receptacles operable to engage one or multiple pins and provisions for connecting a structure or device along a portion of its length;
one or multiple locking pins, said locking pin or multiple pins each comprising a shape, dimensions and material strength operable to engage one or multiple pivot shaft pin receptacles and restrain rotation of the pivot shaft when engaged;
one or multiple springs, said spring or multiple springs comprising a spring force and length sufficient to hold the pivot shaft laterally against the locking pin or multiple pins, move the pivot shaft laterally so as to engage the locking pin or multiple pins with one or multiple pivot shaft receptacles when said pin or multiple pins and receptacle or multiple receptacles align and retain said engagement;
a fixed mount, said fixed mount enclosing the self locking mechanism, said self locking mechanism comprised of a pivot shaft comprising one or multiple locking pin receptacles, one or multiple locking pins and one or multiple springs, said fixed mount structure comprising a housing for the pivot shaft, said pivot shaft housing comprising a non-restraining rotating and sliding fit for the pivot shaft, said fixed mount structure further comprising one or multiple spring cavities, said spring cavities comprising a shape and dimensions that accommodate one or multiple springs, said one or multiple spring cavities further comprising intersection with the pivot shaft housing and operable to interface one or multiple springs with the pivot shaft, said fixed mount further comprising one or multiple holes to accommodate one or multiple locking pins, said locking pin hole or multiple holes intersecting the pivot shaft housing.

2) The enclosed mechanism self locking pivot mount for devices used on machines described in claim 1, where the pin hole in the fixed mount structure is comprised of a shape to accommodate a hexagonal shaped pin, said pin hole perpendicular to the pivot shaft housing and intersecting it in proximity to one end of the pivot shaft housing, where the pivot shaft receptacle is comprised of a slot in one end of the pivot shaft, said slot perpendicular to the longitudinal direction of the pivot shaft and formed to accommodate a hexagonal pin, where the locking pin is comprised of a hexagonal shape and length sufficient to bridge the pivot shaft housing, where the spring is comprised of a cylindrical shaped compression spring located at the opposite end of the pivot shaft housing from the locking pin hole.

3) The enclosed mechanism self locking pivot mount for devices used on machines described in claim 1, where the pin hole in the fixed mount structure is comprised of a shape to accommodate a cylindrical shaped pin, said pin hole parallel to the pivot shaft housing and intersecting the pivot shaft housing in proximity to one end of the pivot shaft housing, where the pivot shaft receptacle is comprised of a cylindrical hole parallel to the longitudinal direction of the shaft, said cylindrical hole formed to accommodate a cylindrical pin, where the locking pin is comprised of a cylindrical shape and length sufficient to engage the pivot shaft cylindrical receptacle, where the spring is comprised of a cylindrical shaped compression spring located at the opposite end of the pivot shaft housing from the locking pin hole.

4) The enclosed mechanism self locking pivot mount for devices used on machines described in claim 1, where multiple pin holes in the fixed mount structure are each comprised of a shape to accommodate a hexagonal shaped pin, said multiple pin holes perpendicular to the pivot shaft housing and intersecting it in proximity to one end of the pivot shaft housing, where the pivot shaft multiple receptacles are each comprised of a slot in one end of the pivot shaft, said multiple receptacle slots perpendicular to the longitudinal direction of the pivot shaft and each formed to accommodate a hexagonal pin, where the multiple locking pins are each comprised of a hexagonal shape and length sufficient to bridge the pivot shaft housing, where the spring is comprised of a cylindrical shaped compression spring located at the opposite end of the pivot shaft housing from the multiple locking pin holes.

5) The enclosed mechanism self locking pivot mount for devices used on machines described in claim 1, where multiple pin holes in the fixed mount structure are each comprised of a shape to accommodate a cylindrical shaped pin, said multiple pin holes parallel to the pivot shaft housing and intersecting the pivot shaft housing in proximity to one end of the pivot shaft housing, where the pivot shaft multiple receptacles are each comprised of a cylindrical hole parallel to the longitudinal direction of the shaft, said cylindrical holes formed to accommodate a cylindrical locking pin, where said multiple locking pins are each comprised of a cylindrical shape and length sufficient to engage one or multiple pivot shaft cylindrical receptacles, where the spring is comprised of a cylindrical shaped compression spring located at the opposite end of the pivot shaft housing from the multiple locking pin holes.
